(19) United States
(12) Patent Application Publication
(10) Pub. No.: US 2008/0056557 A1
(43) Pub. Date: Mar. 6, 2008

(54) System and method for analyzing a light beam of a wafer inspection tool or an exposure tool

(75) Inventors: J.E. Patrick Gagnon, Plano, TX (US); Chris Dale Atkinson, Lewisville, TX (US); Richard L. Guldi, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/514,798

(22) Filed: Aug. 31, 2006

(51) Int. Cl. G06K 9/00

(52) U.S. Cl. 382/144

(57) ABSTRACT

A system operable to detect a light beam generated by a light source includes a substrate that comprises a wafer operable to be inspected by a wafer inspection tool or exposed by an exposure tool. One or more image sensors are disposed outwardly from the substrate. An image sensor of the one or more image sensors is operable to detect a light beam and generate a sensor signal representing the detected light beam.

### TECHNICAL FIELD OF THE INVENTION

This invention relates generally to the field of integrated circuits and more specifically to a system and method for analyzing a light beam of a wafer inspection tool or an exposure tool.

### BACKGROUND OF THE INVENTION

Light beams are used in many processes during the manufacturing of integrated circuits. As an example, light beams may be used in photolithographic processes to define patterns on integrated circuits. As another example, light beams may be used in wafer inspection to identify the defects of integrated circuits.

The light beams used in these processes may be analyzed to check the ability of the beams to satisfy the demands of the processes. Known techniques for analyzing light beams, however, may not be satisfactorily efficient and accurate in certain situations. Consequently, known techniques for analyzing light beams may be unsatisfactory in certain situations.

### SUMMARY OF THE INVENTION

In accordance with the present invention, disadvantages and problems associated with previous techniques for analyzing light beams may be reduced or eliminated.

According to one embodiment of the present invention, a system operable to detect a light beam generated by a light source includes a substrate that comprises a wafer operable to be inspected by a wafer inspection tool or exposed by an exposure tool. One or more image sensors are disposed outwardly from the substrate. An image sensor of the one or more image sensors is operable to detect a light beam and generate a sensor signal representing the detected light beam.

Certain embodiments of the invention may provide one or more technical advantages. A technical advantage of one embodiment may be that a light beam at a target level may be detected. As an example, a light beam at a wafer may be detected. Detecting the light beam at the wafer may provide a more accurate description of how the beam interacts with the wafer.

Another technical advantage of one embodiment may be that features of a light beam may be detected and reported in substantially real time. Detecting and reporting the features in substantially real time may allow for ready adjustment of the light beam source. Another technical advantage of one embodiment may be that features of a light beam may be reported over a wireless link or stored at the wafer for downloading. Reporting the features over a wireless link may allow for efficient reporting of the features.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a system operable to detect a light beam at a target level;

FIGS. 2A through 2C illustrate examples of results of beam analysis;

FIG. 3 is a diagram illustrating a wafer inspection tool that uses a light beam that may be detected and analyzed using one embodiment of the system of FIG. 1;

FIG. 4 is a block diagram of one embodiment of a testing wafer that may be used to detect a light beam of the wafer inspection tool of FIG. 3;

FIG. 5 is a diagram illustrating an exposure tool that uses a light beam that may be detected and analyzed using one embodiment of the system of FIG. 1;

FIGS. 6A and 6B are views of one embodiment of a system that may be used to detect a light beam of the exposure tool of FIG. 5; and

FIG. 7 is a block diagram of another embodiment of a system that may be used to detect a light beam of the exposure tool of FIG. 5.

### DETAILED DESCRIPTION OF THE DRAWINGS

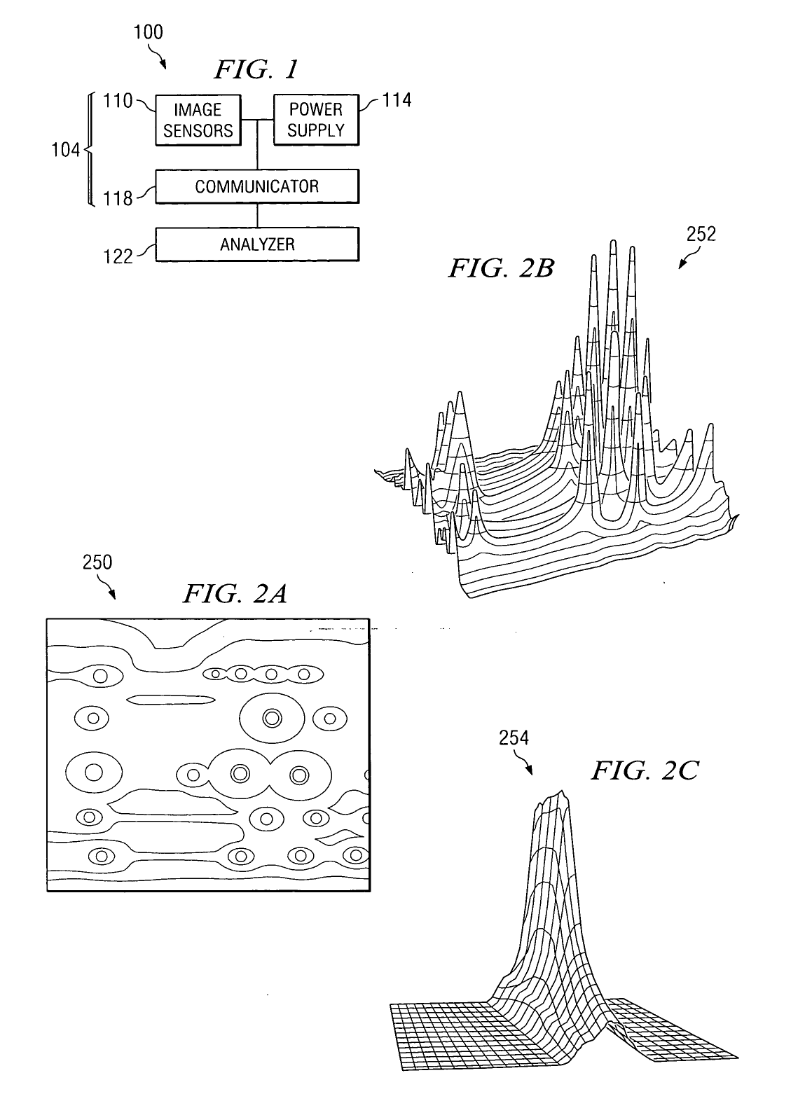

Embodiments of the present invention and its advantages are best understood by referring to FIGS. 1 through 7 of the drawings, like numerals being used for like and corresponding parts of the various drawings.

FIG. 1 is a block diagram illustrating a system 100 operable to detect a light beam at a target level. As an example, a light beam at a wafer may be detected. Detecting the light beam at the wafer may provide a more accurate description of how the beam interacts with the wafer. As another example, a light beam at a photomask may be detected. Detecting the light beam at the photomask may provide a more accurate description of how the beam interacts with the photomask.

System 100 may be used to detect any suitable light beam. The detected light beam may have any suitable wavelength, for example, greater than 100, 200, 300, 400, 500, or 600 nanometers. The light beam may be generated by any suitable light source, for example, a laser.

According to the illustrated embodiment, system 100 includes a detection system 104 and an analyzer 122 coupled by a wired or wireless link. Detection system 104 is operable to detect a light beam, and includes one or more image sensors 110, a power supply 114, a communicator 118 coupled as shown.

Image sensors 110 detect light from a light source and generate a sensor signal that represents the detected light. An image sensor 110 may comprise any suitable device of any suitable size and shape. For example, image sensor 110 may comprise a charge-coupled device (CCD) having a substantially square, rectangular, or linear shape.

An image sensor 110 may have any suitable spectral response. The spectral response may be selected to have a spectral response corresponding to the wavelength of the light beam to be detected. The one or more image sensors 110 may have the same or different spectral responses.

Power supply 114 supplies power for the operation of image sensor 110 and communicator 118. Power supply 114 may comprise a battery, such as a rechargeable battery.

Communicator 118 communicates with analyzer 122, and may communicate the sensor signal representing the detected light beam to analyzer 122. Communicator 118 may include any suitable components for communicating with analyzer 122. For example, communicator 118 may comprise an integrated circuit with a digital signal processor and communication circuitry.

Communicator 118 may communicate with analyzer 122 over a wired or wireless link. As an example, communicator 118 may comprise electrical contacts that may be coupled to a wired link coupled to analyzer 122. As another example, communicator 118 may comprise a wireless communication chip that may communicate over a wireless link according to any suitable technology, for example, the Institute of Electrical and Electronics Engineers, Inc. (IEEE) 802.11 standards.

Analyzer 122 receives the sensor signal representing the detected light beam and analyzes one or more features of the beam. Analyzer 122 may comprise beam analysis software and may provide analysis results in real time. Providing the results in real time may allow ready adjustment of the light source or tool using the light source.

A feature of a light beam may describe any suitable aspect of a beam. As an example, a feature of a light beam may describe a characteristic of the beam itself, such as uniformity, intensity, temporal shape, or optical noise of the beam. As another example, a feature of a light beam may describe a relationship of the beam to a tool, such as the cavity alignment of the beam in a wafer inspection tool.

As yet another example, a feature of a light beam may describe a change in the characteristic of a beam over time, such as a change in beam uniformity from one week to the next. For example, a feature of a light beam may be periodically measured to detect changes in the feature. The measurements of the feature may be compared to establish a delta value that represents differences in the feature from a standard value. Sample analysis results are described with reference to FIGS. 2A through 2C.

FIGS. 2A through 2C illustrate examples of results of beam analysis. FIG. 2A is a diagram 250 illustrating an example of a result from optical noise analysis. FIG. 2B is a diagram 252 illustrating an example of a result of beam uniformity analysis. FIG. 2C is a diagram 254 illustrating an example of a result from intensity analysis.

Referring back to FIG. 1, analyzer 122 may be executed by a computing system. A computing system may include input devices, output devices, mass storage media, processors, memory, or other components for receiving, processing, storing, and communicating information. As used in this document, the term “computer” refers to any suitable device operable to accept input, process the input according to predefined rules, and produce output, for example, a personal computer, work station, network computer, wireless telephone, personal digital assistant, one or more microprocessors within these or other devices, or any other suitable processing device.

Modifications, additions, or omissions may be made to system 100 without departing from the scope of the invention. The components system 100 may be integrated or separated according to particular needs. Moreover, the operations of system 100 may be performed by more, fewer, or other components. For example, the operations of image sensors 110 may be performed by more than one component. As used in this document, “each” may refer to each member of a set or each member of a subset of the set.

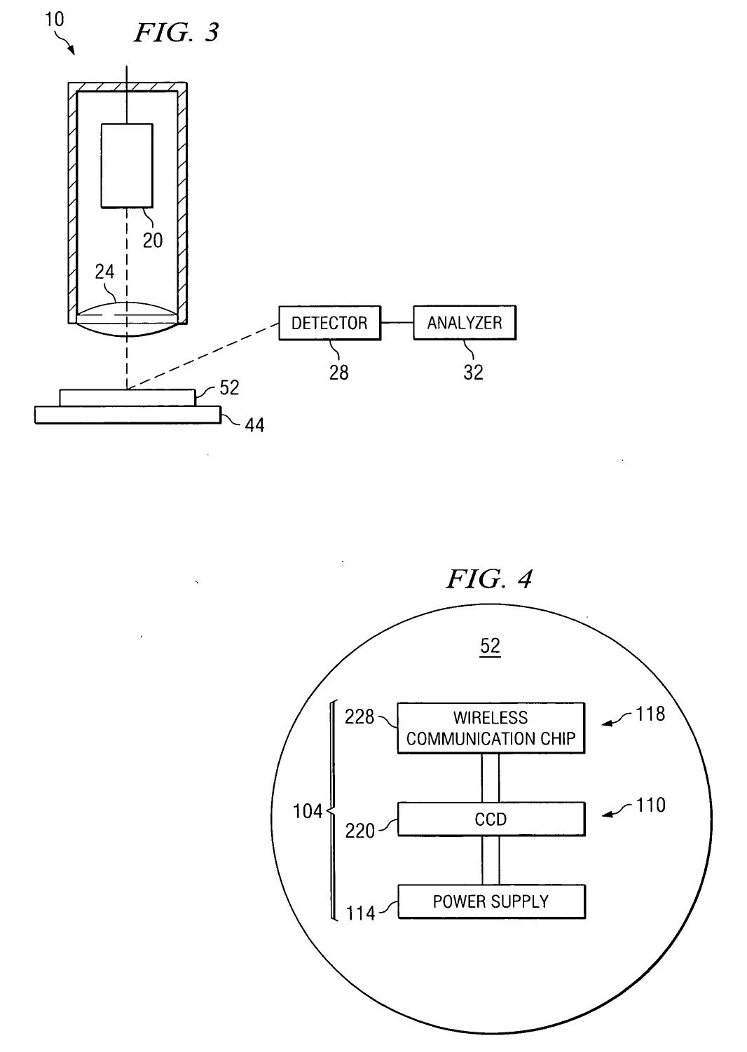

FIG. 3 is a diagram illustrating a wafer inspection tool 10 that uses a light beam that may be detected and analyzed using one embodiment of system 10 of FIG. 1. According to the embodiment, system 10 may detect and analyze a light beam substantially at the surface of a wafer.

According to one embodiment, wafer inspection tool 10 may be used to inspect a wafer for defects. A wafer may refer to a silicon wafer that is used to manufacture an integrated circuit. A silicon wafer has a surface that is inspected for defects. The inspected surface is typically the surface that is patterned. Wafer inspection tool 10 includes a light source 20, an objective lens 24, a detector 28, an inspection analyzer 32, and a wafer stage 44.

To inspect a wafer, the wafer may be placed on wafer stage 44. Light source 20 generates a light beam, and objective lens 24 directs the light beam towards the wafer to create light scattering. Detector 28 detects the light scattering and sends a detector signal representing the light scattering to analyzer 32. Analyzer 32 analyzes the light scattering to detect defects of the wafer.

According to one embodiment, the light beam generated by light source 20 may be analyzed. According to the embodiment, a testing wafer 52 that includes an embodiment of system 100 of FIG. 1 may be placed on wafer stage 44 to detect the light beam substantially at the surface of a wafer. An example of testing wafer 52 is described in more detail with reference to FIG. 4.

Testing wafer 52 may be used to isolate the source of a problem with wafer inspection tool 10. As an example, testing wafer 52 may be used to establish whether the source of the problem is occurring during generation of a light beam or during detection of the reflected light beam. If testing wafer identifies a problem with the light beam, light source 20 may be adjusted to correct the problem. If test wafer 52 establishes that the light beam is satisfactory, detector 28 may be investigated as the source of the problem.

Modifications, additions, or omissions may be made to wafer inspection tool 10 without departing from the scope of the invention. The components of wafer inspection tool 10 may be integrated or separated according to particular needs. Moreover, the operations of wafer inspection tool 10 may be performed by more, fewer, or other modules.

FIG. 4 is a block diagram of one embodiment of testing wafer 52 that may be used to detect a light beam of wafer inspection tool 10 of FIG. 3. Testing wafer 52 includes one embodiment of detection system 104 of FIG. 1 operable to detect a light beam substantially at the surface of a wafer being inspected by wafer inspection tool 10.

Testing wafer 52 represents a silicon wafer that may be inspected by wafer inspection tool 10 of FIG. 1. Detection system 104 may be placed substantially at the surface to be inspected in order to detect a light beam at the surface. Detecting the light beam at the surface may provide a more accurate description of how the beam interacts with the wafer.

According to the illustrated embodiment, detection system 104 includes one or more image sensors 110, power supply 114, and communicator 118 coupled as shown. The one or more image sensors 110 may comprise one or more charge-coupled devices (CCDs) 220 or other suitable image sensors of any suitable size or shape.

Communicator 118 communicates a sensor signal from image sensors 110 to a computer system comprising an analyzer 122 of FIG. 1. According to one embodiment, communicator 118 may comprise a wireless communication chip operable to communicate with the computer system over a wireless link. According to another embodiment, communicator 118 may comprise electrical contacts that communicate the sensor signal to a memory associated with wafer stage 44 of FIG. 3.

Modifications, additions, or omissions may be made to testing wafer 52 without departing from the scope of the invention. The components of testing wafer 52 may be integrated or separated according to particular needs. Moreover, the operations of testing wafer 52 may be performed by more, fewer, or other modules.

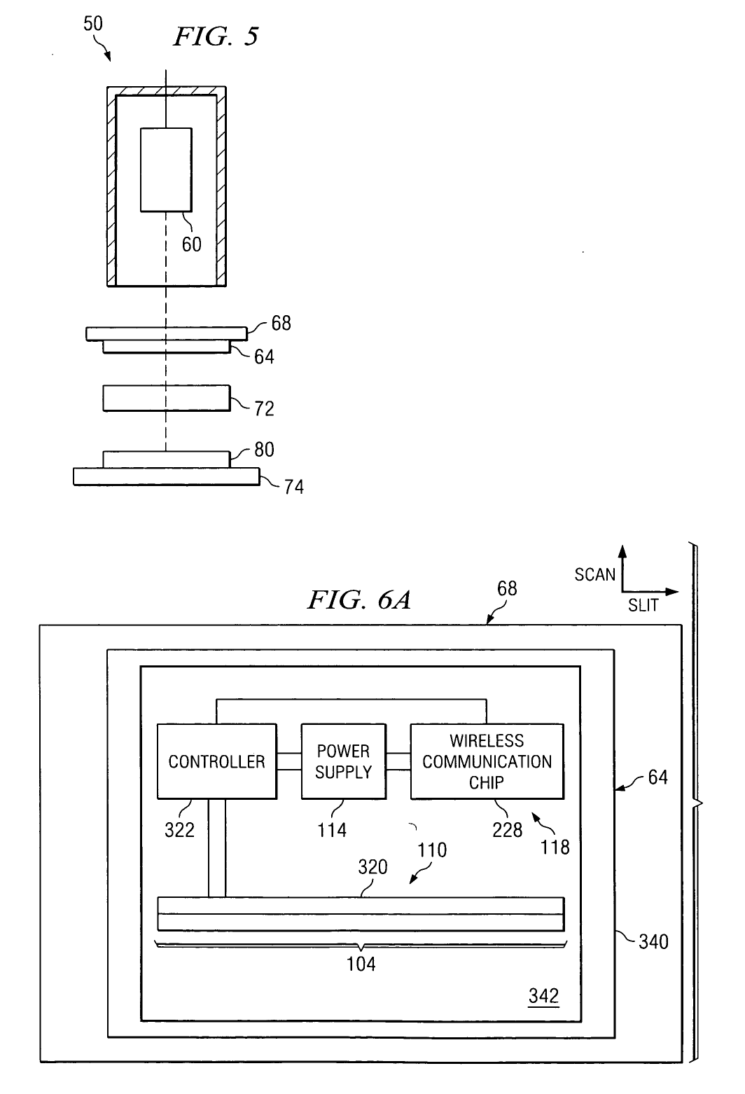

FIG. 5 is a diagram illustrating an exposure tool 50 that uses a light beam that may be detected and analyzed using one embodiment of system 10 of FIG. 1. According to the embodiment, system 10 may detect and analyze a light beam substantially at the photomask level.

According to one embodiment, exposure tool 50 may be used to define a pattern on a wafer 80. Exposure tool 50 includes a light source 60, a substrate 64, a photomask 68, a projection lens 72, and a wafer stage 74, which are used to define a pattern on a wafer 80.

To define a pattern on wafer 80, wafer 80 may be placed on wafer stage 74. Light source 60 generates a light beam to illuminate photomask 68 to form a pattern on wafer 80. Photomask 68 may be illuminated in any suitable manner. For example, a long, thin slit portion of wafer 80 may be exposed through a slit aligned in a slit direction. The slit may be moved in a scan direction perpendicular to the slit direction. Projection lens 72 collects light passing through photomask 68 and directs the light to wafer 80.

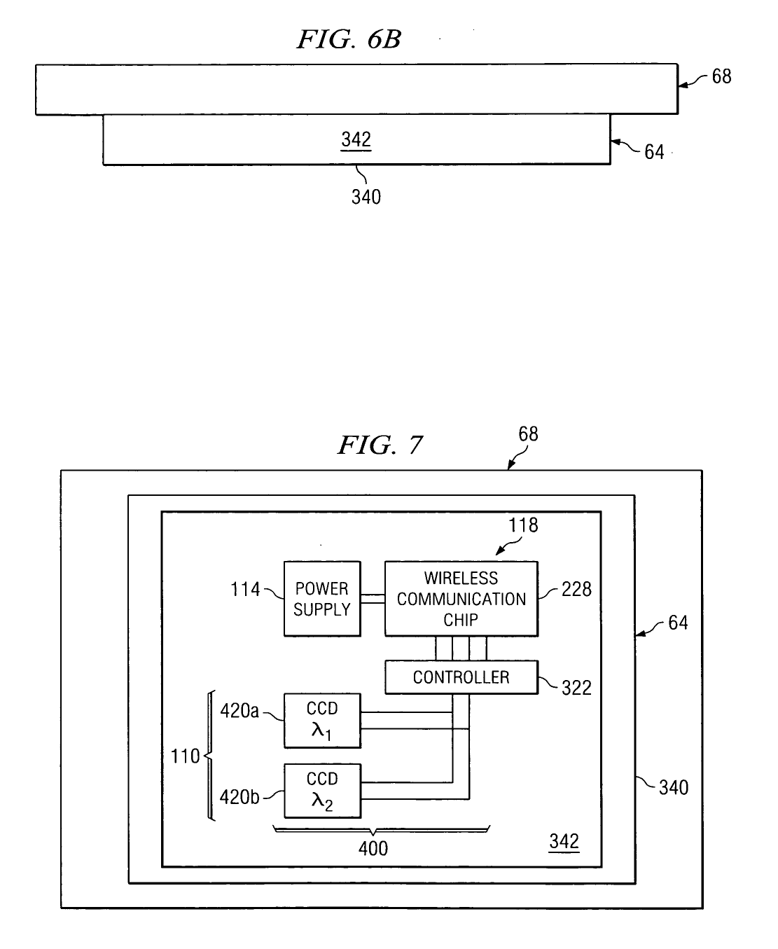

According to one embodiment, the light beam generated by light source 60 may be analyzed. According to the embodiment, an embodiment of system 10 may detect the light beam substantially at substrate 64. An example of system 10 is described in more detail with reference to FIGS. 5 and 6.

Modifications, additions, or omissions may be made to exposure tool 50 without departing from the scope of the invention. The components of exposure tool 50 may be integrated or separated according to particular needs. Moreover, the operations of exposure tool 50 may be performed by more, fewer, or other modules.

FIGS. 6A and 6B are views of one embodiment of a system that may be used to detect and evaluate a light beam of exposure tool 50 of FIG. 5. An embodiment of detection system 104 of FIG. 1 is operable to detect a light beam substantially at the photomask level of exposure tool 50.

Referring to FIG. 6A, the system includes detection system 104 and frame 340 coupled to photomask 68. Detection system 104 may be coupled to frame 340 of substrate 64 by a circuit board 342. According to the illustrated embodiment, detection system 104 includes one or more image sensors 110, a controller 332, power supply 114, and communicator 118 coupled as shown.

According to one embodiment, the one or more image sensors 110 may comprise a charge-coupled device 320 of any suitable size or shape. According to the embodiment, charge-coupled device 320 may have a linear shape that substantially replicates the slit portion of a wafer 80 exposed by exposure tool 50. For example, linear charge-coupled device 320 may have a size of approximately five by at least thirty millimeters, for example, approximately thirty-three millimeters. The linear charge-coupled device 320 may be aligned in a slit direction. Controller 322 moves charge-coupled device 320 in a scan direction substantially perpendicular to the slit direction. Controller 322 substantially simulates the movement of exposure by exposure tool 50.

Communicator 118 communicates a sensor signal from image sensors 110 to a computer system comprising an analyzer 122 of FIG. 1. According to one embodiment, communicator 118 may comprise a wireless communication chip 228 operable to communicate with a computer system over a wireless link.

Referring to FIG. 6B, substrate 64, frame 340, and circuit board 342 may be coupled to photomask 68 as shown.

Modifications, additions, or omissions may be made to the system without departing from the scope of the invention. The components of the system may be integrated or separated according to particular needs. Moreover, the operations of the system may be performed by more, fewer, or other modules. For example, the operations of controller 322 may be performed by more than one module.

FIG. 7 is a block diagram of another embodiment of a system that may be used to detect a light beam of exposure tool 50 of FIG. 5. An embodiment of detection system 104 of FIG. 1 is operable to detect a light beam substantially at the photomask level of exposure tool 50.

According to the illustrated embodiment, the system includes detection system 104 and frame 340 coupled to photomask 68. Detection system 104 may be coupled to frame 340 of substrate 64 by circuit board 342. According to the illustrated embodiment, detection system 104 includes one or more image sensors 110, controller 332, power supply 114, and communicator 118 coupled as shown.

According to one embodiment, the one or more image sensors 110 may comprise a plurality of charge-coupled device 420 of any suitable size or shape. Charge-coupled devices 420 may be operable to detect light of any suitable wavelengths, for example, the wavelengths of light beams used by exposure tool 50. As an example, a first image sensor 420a may be operable to detect light beams at a first wavelength, for example, 257 nanometers, and a second image sensor 420b is operable to detect light having a second wavelength, for example, 365 nanometers. A shorter wavelength may be used to see smaller defects and a larger wavelength may be used to see larger defects. Controller 322 moves charge-coupled devices 320 to substantially simulate the movement of exposure by exposure tool 50.

Communicator 118 communicates a sensor signal from image sensors 110 to a computer system comprising an analyzer 122 of FIG. 1. According to one embodiment, communicator 118 may comprise a wireless communication chip 228 operable to communicate with a computer system over a wireless link.

Modifications, additions, or omissions may be made to the system without departing from the scope of the invention. The components of the system may be integrated or separated according to particular needs. Moreover, the operations of the system may be performed by more, fewer, or other modules.

Certain embodiments of the invention may provide one or more technical advantages. A technical advantage of one embodiment may be that a light beam at a target level may be detected. As an example, a light beam at a wafer may be detected. Detecting the light beam at the wafer may provide a more accurate description of how the beam interacts with the wafer.

Another technical advantage of one embodiment may be that features of a light beam may be detected and reported in substantially real time. Detecting and reporting the features in substantially real time may allow for ready adjustment of the light beam source. Another technical advantage of one embodiment may be that features of a light beam may be reported over a wireless link. Reporting the features in over a wireless link may allow for efficient reporting of the features.

Although an embodiment of the invention and its advantages are described in detail, a person skilled in the art could make various alterations, additions, and omissions without departing from the spirit and scope of the present invention as defined by the appended claims.

What is claimed is:

1. A system operable to detect a light beam generated by a light source, comprising:
a substrate comprising a wafer, the wafer operable to be inspected by a wafer inspection tool;
one or more image sensors disposed outwardly from the substrate, an image sensor of the one or more image sensors further comprising a charge-coupled device, the image sensor of the one or more image sensors operable to:
detect a light beam; and
generate a sensor signal representing the detected light beam, the one or more image sensors further comprising:
a first image sensor operable to detect light of a first wavelength; and
a second image sensor operable to detect light of a second wavelength, the first wavelength different from the second wavelength, the one or more image sensors disposed outwardly from a surface of the substrate, the surface representing a patterned surface of the wafer;
a wireless communication chip disposed outwardly from the substrate and operable to transmit the sensor signal over a wireless link;
an electrical contact coupled to the one or more image sensors and operable to communicate the sensor signal over a wired link;
a power supply disposed outwardly from the substrate and operable to supply power to the one or more image sensors;
a controller operable to move at least one image sensor of the one or more image sensors; and
an analyzer operable to:
receive the sensor signal; and
analyze the light beam in accordance with the sensor signal.

2. A system operable to detect a light beam generated by a light source, comprising:
a substrate comprising a wafer, the wafer operable to be inspected by a wafer inspection tool; and
one or more image sensors disposed outwardly from the substrate, an image sensor of the one or more image sensors operable to:
detect a light beam; and
generate a sensor signal representing the detected light beam.

3. The system of claim 2, further comprising:
a wireless communication chip disposed outwardly from the substrate and operable to transmit the sensor signal over a wireless link.

4. The system of claim 2, further comprising:
an electrical contact coupled to the one or more image sensors and operable to communicate the sensor signal over a wired link.

5. The system of claim 2, further comprising:
a power supply disposed outwardly from the substrate and operable to supply power to the one or more image sensors.

6. The it claim 2, further comprising circuitry disposed outwardly from the substrate that is operable to receive power transmitted wirelessly.

7. The system of claim 2, wherein the one or more image sensors further comprises:
a first image sensor operable to detect light of a first wavelength; and
a second image sensor operable to detect light of a second wavelength, the first wavelength different from the second wavelength.

8. The system of claim 2, further comprising:
a controller operable to move at least one image sensor of the one or more image sensors.

9. The system of claim 2, further comprising an analyzer operable to:
receive the sensor signal; and
analyze the light beam in accordance with the sensor signal.

10. The system of claim 2, wherein the one or more image sensors are disposed outwardly from a surface of the substrate, the surface representing a patterned surface of the wafer.

11. The system of claim 2, wherein an image sensor of the one or more image sensors further comprises a charge-coupled device.

12. A method for detecting a light beam generated by a light source, comprising:
illuminating a substrate with a light beam of a wafer inspection tool, the substrate comprising a wafer operable to be inspected by the wafer inspection tool;
detecting a light beam using one or more image sensors disposed outwardly from the substrate; and
generating a sensor signal representing the detected light beam.

13. The method of claim 12, further comprising:
transmitting the sensor signal over a wireless link using a wireless communication chip disposed outwardly from the substrate.

14. The method of claim 12, further comprising:
communicating the sensor signal over a wired link using an electrical contact coupled to the one or more image sensors.

15. The method of claim 12, further comprising:
supplying power to the one or more image sensors using a power supply disposed outwardly from the substrate.

16. The method of claim 12, further comprising supply power wirelessly to the image sensors.

17. The method of claim 12, wherein the one or more image sensors further comprises:
a first image sensor operable to detect light of a first wavelength; and
a second image sensor operable to detect light of a second wavelength, the first wavelength different from the second wavelength.

18. The method of claim 12, further comprising:
moving at least one image sensor of the one or more image sensors using a controller.

19. The method of claim 12, further comprising:
receiving the sensor signal at an analyzer; and
analyzing the light beam in accordance with the sensor signal.

20. The method of claim 12, wherein the one or more image sensors are disposed outwardly from a surface of the substrate, the surface representing a patterned surface of the wafer.

21. The method of claim 12, wherein an image sensor of the one or more image sensors further comprises a charge-coupled device.

22. A system for detecting a light beam generated by a light source, comprising:
means for illuminating a substrate with a light beam of a wafer inspection tool, the substrate comprising a wafer operable to be inspected by the wafer inspection tool;
means for detecting a light beam using one or more image sensors disposed outwardly from the substrate; and
means for generating a sensor signal representing the detected light beam.
